(19) United States
(12) Patent Application Publication
(10) Pub. No.: US 2023/0332033 A1
(43) Pub. Date: Oct. 19, 2023

(54) COMPOSITE MATERIAL FOR THERMOCHEMICAL ENERGY STORAGE AND METHOD OF MAKING SAME

(71) Applicant: University of Ottawa, Ottawa (CA)

(72) Inventors: Handan Tenzel, Ottawa (CA); Suboohi Shervani, Ottawa (CA); Curtis Strong, Ottawa (CA)

(21) Appl. No.: 18/300,754

(22) Filed: Apr. 14, 2023

Related U.S. Application Data
(60) Provisional application No. 63/330,819, filed on Apr. 14, 2022.

(51) Int. Cl. C09K 5/16

(52) U.S. Cl. CPC C09K 5/16

(57) ABSTRACT

Composite material for thermochemical energy storage (TCES). The material comprises a salt hydrate that is impregnated into a matrix and encapsulated by a polymer. In some embodiments, the matrix is a gel matrix. In some embodiments, the gel matrix is silica gel. In some embodiments, the polymer is methylcellulose. In preferred embodiments, the impregnation and encapsulation are performed simultaneously. The material is created by mixing the components, stirring the mixture for a predetermined time, and drying the mixture at a predetermined temperature for a predetermined time.

### RELATED APPLICATIONS

This application claims the benefit of U.S. Provisional Patent Application No. 63/330,819 filed on Apr. 14, 2022.

### TECHNICAL FIELD

The present invention relates to thermochemical energy storage (TCES). More specifically, the present invention relates to a composite material for TCES and a method of making the same.

### BACKGROUND

In view of increasing climate change and the transition away from carbon-intensive and non-renewable fuel sources, both the supply of and demand for renewable thermal and electrical energy sources are increasing consistently and significantly worldwide.

Renewable energy sources offer numerous advantages including reduced local emissions and greater sustainability. However, the energy output of renewable energy sources is temporally inconsistent. For example, solar panels have a greater energy output during summer months than in winter months in the northern hemisphere, due to elevated solar irradiation levels in the summer months. This issue is exacerbated by the fact that the energy demand is also inconsistent. For example, in Canada, there is a greater demand for space heating in the winter months than in the summer months. One way to resolve this mismatch is to store excess energy produced by renewable energy sources and then release it when it is needed.

Thermal energy can either (i) be converted to another type of energy, such as electricity, and be stored in conventional energy storage units (e.g., batteries), or (ii) be stored directly as thermal energy. Converting heat to electricity is costly and inefficient.

As such, thermal energy storage (TES) techniques are of interest. Conventional TES methods include sensible, latent, and thermochemical thermal energy storage.

Sensible heat storage typically involves a heavily insulated hot water tank, or other media, whose temperature is increased by heating it with excess thermal energy, then the energy is stored until it is required. This simple method is the most common form of TES, but is subject to significant heat losses over time and has low energy storage density (ESD) (≈30 kWh/m3). This means that large volumes of water or other fluid are required to store useful amounts of heat. This is impractical in many residential and industrial settings, since buildings do not generally have free space to retrofit large infrastructure.

Latent heat TES is another technology that is being developed, in which energy is stored by heating a solid until the solid liquefies. The energy is later released by allowing the liquid to solidify. This method has higher energy densities but also loses heat over time, and many of the proposed phase-change materials are toxic and/or corrosive.

Thermochemical energy storage (TCES or thermochemical TES) techniques store excess heat by using the heat to reverse an exothermic physical or chemical process, such as adsorption or hydration reactions. The stored heat is later released by allowing the physical or chemical process to proceed. Compared to other TES techniques, thermochemical TES exhibits exceptionally high ESD values, rarely require any toxic or corrosive chemicals, and can store heat indefinitely. As a result, adsorption-based TES appears very useful for compact energy storage applications.

However, adsorption-based energy storage has yet to be commercialized successfully. In part, this is due to a lack of suitable storage materials that are cost-effective and widely available.

Salt hydration/dehydration reactions have been favourable options for space heating and domestic hot water applications, due to their optimal operating temperature ranges that are suitable for domestic and commercial use, high energy density values, and lack of toxic chemicals (see references [1 to 3]). One popular reaction involves the hydration/dehydration of calcium chloride (CaCl₂). This salt has favourable hydration and dehydration temperatures, is non-toxic, is inexpensive and readily available, has a high heat of sorption, and a large water vapour sorption capacity.

However, CaCl₂ has been criticized for its low temperature lifts [2]. Further, CaCl₂ and many other hygroscopic salts with high water sorption capacity experience practical issues like deliquescence, swelling, particle agglomeration, which lead to lack of cyclic stability [2]. As such, a variety of attempts have been made to mitigate these issues by impregnating porous matrix materials with CaCl₂ and other hygroscopic salts. Matrix materials used have included, without limitation, alumina, carbonaceous materials, cement, porous silica, metal-organic-frameworks (MOFs) and zeolites. Some researchers have also attempted encapsulation of the salts in polymeric coatings and hollow spheres in order to stabilize them, as well as the encapsulation of phase change materials (PCMs). These techniques have successfully increased the stability of hygroscopic salts and PCMs, although many of these composites still experience a decrease in performance after multiple hydration and dehydration cycles [4].

Silica gel, a porous, amorphous, and widely available commercial desiccant, has been used in several tests as a matrix material for hydration/dehydration material stabilization, including for stabilization of CaCl₂. Other silica-based materials have also been used. However, the silica/CaCl₂ composites lack stability. Encapsulating salts, such as CaCl₂, with polymers such as ethyl cellulose, has also been found to produce stabilizing effects on the salts. However, swelling and agglomeration were still present for ethyl cellulose-coated CaCl₂.

As such, there is a need for energy storage materials that overcome the issues and shortcomings of the prior art.

### SUMMARY

This document discloses a composite material for TCES. The material comprises a salt hydrate that is impregnated into a matrix and encapsulated by a polymer. In some embodiments, the matrix is a gel matrix. In some embodiments, the gel matrix is silica gel. In some embodiments, the polymer is methylcellulose. In preferred embodiments, the impregnation and encapsulation are performed simultaneously. The material is created by mixing the components, stirring the mixture for a predetermined time, and drying the mixture at a predetermined temperature for a predetermined time.

In a first aspect, this document discloses a composite material for thermochemical energy storage (TCES), said material comprising: at least one of a salt hydrate and a salt hydrate composite; a matrix; and a polymer, wherein said at least one of said salt hydrate and said salt hydrate composite is impregnated into said matrix to thereby produce an impregnated matrix, and wherein said impregnated matrix is encapsulated by said polymer.

In another embodiment, this document discloses a material wherein said matrix is a gel matrix.

In another embodiment, this document discloses a material wherein said at least one of said salt hydrate and said salt hydrate composite is calcium chloride (CaCl₂).

In another embodiment, this document discloses a material wherein said at least one of said salt hydrate and said salt hydrate composite is a calcium chloride-based composite.

In another embodiment, this document discloses a material wherein said matrix is silica gel.

In another embodiment, this document discloses a material wherein said polymer is methyl cellulose (MC).

In another embodiment, this document discloses a material wherein encapsulation of said impregnated matrix and impregnation of said matrix with said at least one of said salt hydrate and said salt hydrate composite are performed simultaneously.

In another embodiment, this document discloses a material said material further comprising ethanol.

In a second aspect, this document discloses a method of producing a composite material for thermochemical energy storage (TCES), said method comprising: combining a matrix, a polymer, deionized water, and at least one of a salt hydrate and a salt hydrate composite to form a mixture; stirring said mixture, such that said at least one of said salt hydrate and said salt hydrate composite is impregnated into said matrix to thereby produce an impregnated matrix, and said impregnated matrix is encapsulated by said polymer; and drying said mixture to thereby produce said composite material.

In another embodiment, this document discloses a method wherein said matrix is a gel matrix.

In another embodiment, this document discloses a method wherein said at least one of said salt hydrate and said salt hydrate composite is calcium chloride (CaCl₂).

In another embodiment, this document discloses a method wherein said at least one of said salt hydrate and said salt hydrate composite is a calcium chloride-based composite.

In another embodiment, this document discloses a method wherein said matrix is silica gel.

In another embodiment, this document discloses a method wherein said polymer is methylcellulose (MC).

In another embodiment, this document discloses a method wherein ethanol is also combined in said mixture.

In a third aspect, this document discloses a composite material for thermochemical energy storage (TCES), said material comprising: a hygroscopic salt; and a polymer, wherein said polymer encapsulates said hygroscopic salt and wherein said polymer is methylcellulose.

### BRIEF DESCRIPTION OF THE DRAWINGS

The present invention will now be described by reference to the following figures, in which identical reference numerals refer to identical elements and in which:

FIG. 1A is a schematic representation of an impregnation process according to an aspect of the invention;

FIG. 1B is a schematic representation of an impregnation-encapsulation process according to an aspect of the invention;

FIG. 2 is a schematic diagram of an energy storage apparatus used in experimental tests;

FIGS. 3A-3D show energy storage density (ESD), maximum thermal power, specific energy (SE), and water-vapour uptake capacity for various materials in experimental tests, including a material according to the present invention;

FIG. 4 shows bulk density of the materials in the experimental tests of FIG. 3;

FIG. 5 shows temperature breakthrough curves for the materials in the experimental tests of FIG. 3;

FIG. 6 shows concentration breakthrough curves for the materials in the experimental tests of FIG. 3;

FIG. 7 shows energy storage performance curves for a material according to an aspect of the invention;

FIGS. 8A and 8B show breakthrough curves for the material of FIG. 7; and

FIG. 9 is a flowchart detailing a method according to an aspect of the invention.

### DETAILED DESCRIPTION

This document discloses a salt-hydrate-based composite material for use in thermal energy storage, at a predetermined set of temperatures and relative humidity levels and other specific process conditions. In particular, this document discloses a material comprising a matrix, methylcellulose, and a salt hydrate or salt hydrate composite. In some embodiments, the matrix is a gel matrix. Other matrix materials that may be used include, without limitation, activated alumina, flax shives, zeolites, etc. As well, other encapsulation agents, such as ethyl cellulose, may be used in the invention.

To form the material, the salt hydrate and/or salt hydrate composite is impregnated into the pores of the matrix and the impregnated matrix is encapsulated by the methylcellulose. The impregnation and encapsulation are, in some embodiments, performed simultaneously. These processes are performed by combining the components, allowing them to mix such that impregnation and encapsulation occur, and drying the mixture to produce a solid material. Ethanol and/or deionized water, depending on the embodiment, are used as purification agents and/or to facilitate mixing.

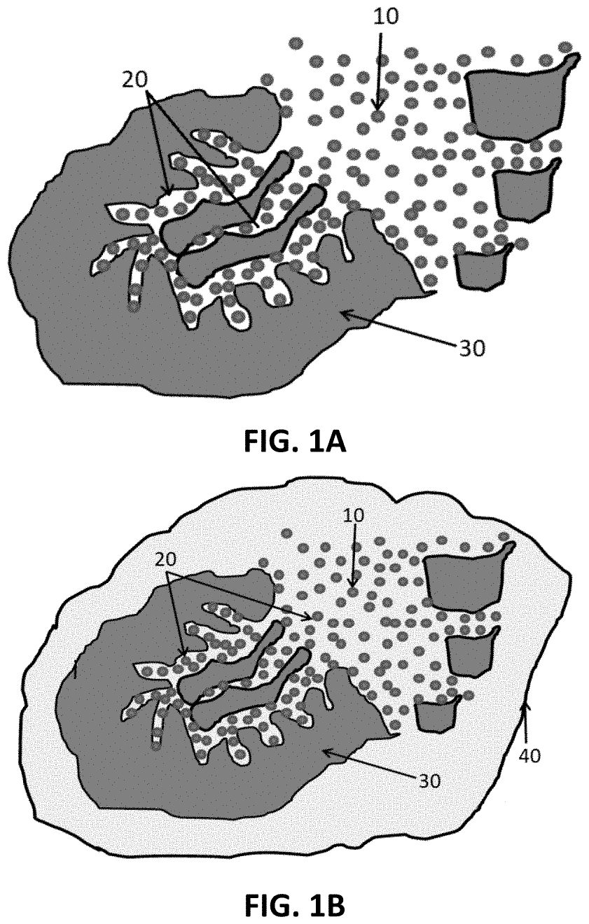

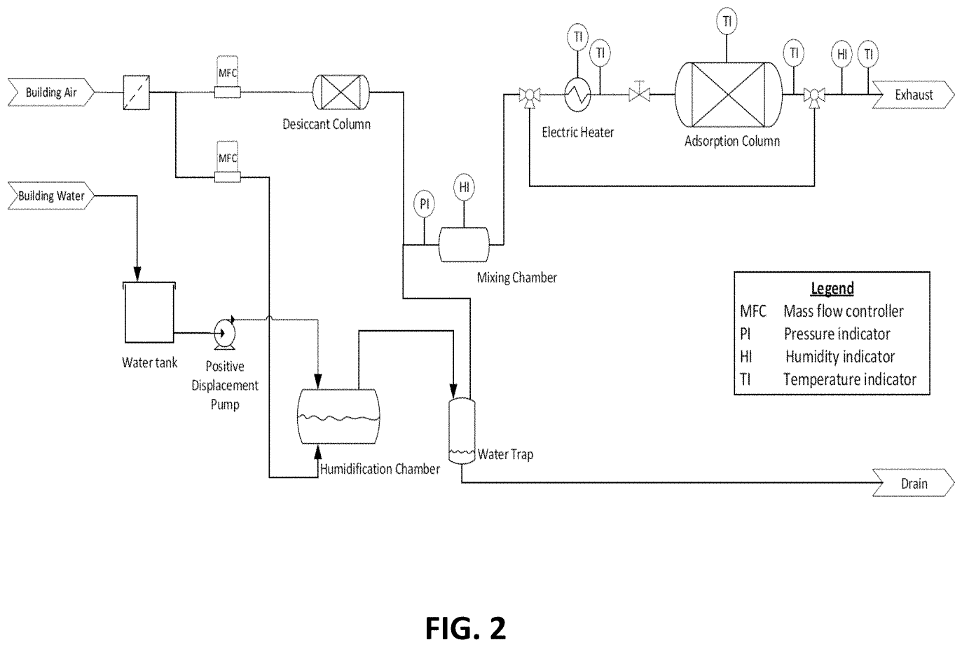

FIGS. 1A and 1B show schematic representations of the impregnation and encapsulation processes. In FIG. 1A, salt particles 10 are impregnated into the pores 20 (as well as the exterior surface) of the matrix 30. That is, in the impregnation process, salt is adsorbed to the surface and to the pores of the host matrix material 30. In FIG. 1B, the salt particles 10 and the matrix 30 are shown encapsulated by the polymer 40. As would be understood, during encapsulation, the polymer 40 forms an envelope around the matrix (i.e., the sorbent material). In some embodiments, the encapsulation is performed while the impregnation is occurring.

### Experimental Tests

Several experiments were performed to test the performance of the salt-hydrate-based composite material disclosed herein. In particular, the energy storage performance of the following materials was assessed: (i) pure silica gel, (ii) silica gel impregnated with salt composites (specifically, with CaCl₂); (iii) salt composites encapsulated by methylcellulose; and (iv) salt composites simultaneously impregnated into silica gel and encapsulated by methylcellulose.

Although these experiments were only performed with specific materials/compounds (i.e., CaCl₂, silica gel, and methylcellulose), nothing in the following description should be construed as limiting the present invention in any way. In particular, nothing in the experimental setup or discussion is intended to or should be construed as preventing the use of different, similar materials or manufacturing parameters, as would be understood by the person skilled in the art. As a non-limiting example, other salt hydrates or salt hydrate composites could be used in place of the CaCl₂, including without limitation calcium chloride-based composites. As other non-limiting examples, other salts may include MgSO₄, MgCl₂, and others.

### Nomenclature

The following abbreviations and variables will be used in the following discussion:

TABLE 1
Nomenclature.

| Abbreviation | Meaning |
|---|---|
| C_{p, air} | Heat capacity of air (kJ/kg ° C.) |
| H | Absolute humidity (g/g) |
| Hᵢₙₗₑₜ | Absolute humidity at the column inlet (g/g) |
| Hₒᵤₜₗₑₜ | Absolute humidity at the column outlet (g/g) |
| L | Length of the column (cm) |
| \dot{m}ₐᵢᵣ | Mass flow rate of air (g/min) |
| M | Mass of the adsorbent in the column (g) |
| Mₐᵢᵣ | Molar mass of dry air (kg/kmol) |
| M_{H2O} | Molar mass of water (kg/kmol) |
| p_{H2O}^{sat} | Saturation vapour pressure of water (kPa) |
| Pₜₒₜ | Total pressure (kPa) |
| q | Water vapour uptake capacity (g/g) |
| Q_{hydration} | Energy released during hydration (kJ) |
| \dot{Q}ₘₐₓ | Maximum thermal power (W) |
| RH | Relative humidity (%) |
| t | Time (min) |
| Tᵢₙ | Inlet temperature (° C.) |
| Tₒᵤₜ | Outlet temperature (° C.) |
| V | Volume of the column (cm³) |
| x_{H2O} | Water-vapour concentration |
| ΔTₘₐₓ | Maximum temperature difference (° C.) |
| ρ_{bulk} | Bulk density (kg/m³) |
| Ø | Diameter (cm) |

### Materials and Material Preparation

Silica gel was provided from Xebec Adsorption Inc.™ (Blainville, QC, Canada) and the CaCl₂ and LiCl were purchased from Fisher Scientific™ (Ottawa, ON, Canada). Methyl cellulose was purchased from Sigma Aldrich, Canada™ (Oakville, ON, Canada). A table listing all of the composites and their abbreviated names are provided in Table 2, below. Various times, temperatures, concentrations, and other variables are described below. It should be clear that other times, temperatures, and concentrations may be used, depending on the specific matrix, salt, etc. The person skilled in the art would be able to select suitable ranges and values for relevant variables. The operating conditions for this embodiment of the invention are: 120° C. regeneration temperature and 90% relative humidity (RH). At this combination, the specific energy of MC/SG/CaCl₂ is 630 Wh/kg.

TABLE 2
Materials tested and their abbreviated names.

| Composite | Acronym |
|---|---|
| Pure silica gel | Pure SG |
| Silica gel/CaCl₂ | SG/CaCl₂ |
| Methyl cellulose/CaCl₂ | MC/CaCl₂ |
| Methyl cellulose + silica gel/CaCl₂ | MC + SG/CaCl₂ |
| Methyl cellulose + silica gel/LiCl | MC + SG/LiCl |

### SG/CaCl₂ Synthesis

30 g of silica gel was kept inside a beaker filled with 100 ml ethanol for half an hour to remove impurities and contaminants. The silica gel was then extracted from ethanol. 15 g of CaCl₂ was then mixed with the 30 g of silica gel in 100 ml de-ionized (DI) water. The solution was stirred continuously for 24 h. The mixture was dried for 6 h at 120° C. in oven.

### MC/CaCl₂ Synthesis

15 g of CaCl₂ and 10 g MC were mixed together in 100 ml DI water and 5 ml of ethanol was poured into the mixture. The solution was stirred continuously for 24 h. The mixture was dried for 24 h at 90° C. in an oven.

### MC+SG/CaCl₂ Synthesis

30 g of silica gel was kept inside a beaker filled with 100 ml ethanol for half an hour to remove the impurities and contaminations. Silica gel was then extracted from ethanol. 15 g CaCl₂, 10 g MC and 30 g silica gel were mixed together in 100 ml de-ionized (DI) water and 5 ml of ethanol was poured into the mixture. The solution was stirred continuously for 24 h. The mixture was then dried for 24 h at 90° C. in an oven.

### MC+SG/LiCl Synthesis

First, 30 g of silica gel was kept inside a beaker filled with 100 ml ethanol for half an hour to remove the impurities and contaminations. Silica gel was then extracted from ethanol. 15 g of LiCl, 10 g MC and 30 g of silica gel were mixed together in 100 ml de-ionized (DI) water and pour 5 ml Ethanol into the mixture. The solution was stirred continuously for 24 h. The mixture was dried for 24 h at 90° C. in an oven.

### Energy Storage Apparatus and Methodology

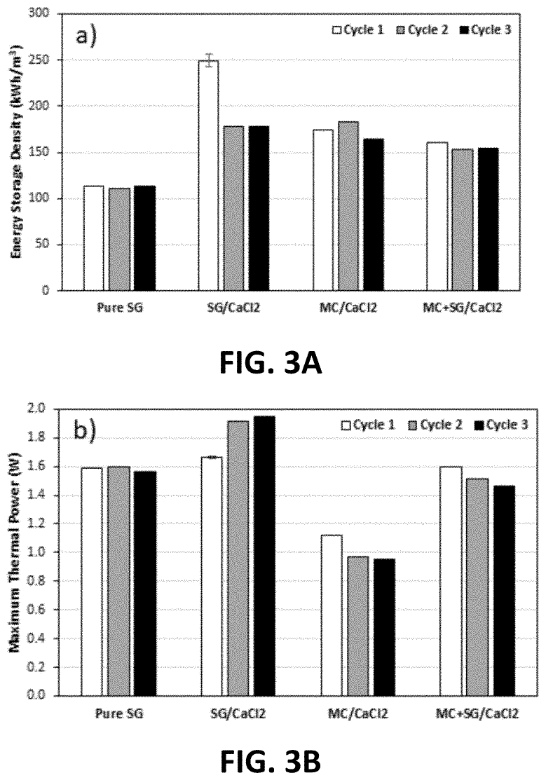

A lab-scale energy storage apparatus was used to test the energy storage performance. The system and methodology used were similar to those described in Reference [10]. The schematic diagram of the energy storage apparatus is depicted in FIG. 2. A stainless-steel sorption column, covered in fiberglass insulation, had a volume of 7.15 cm³, with an inner diameter of 1.09 cm and a length of 7.67 cm. Small pieces of glass wool were placed at the inlet and outlet of the column to avoid particles exiting the column. The column was filled with 2 to 6 g of adsorbent material, depending on the bulk density. The material was crushed and sieved to a 7×20 mesh size (0.841 mm-2.83 mm) using a mortar and a pestle. Note that the MC/CaCl₂ sample was rubbery and elastic, so, unlike the more brittle samples, it could not be crushed with a mortar and pestle. As such, the MC/CaCl₂ sample was chopped into fine pieces using a knife.

To dehydrate each sample and store thermal energy, air with an RH of 0-3% at room temperature (≈22° C.) was heated to 120° C. and forced to flow over the column at a rate of 12 litres per minute (LPM). The flow rate and humidity levels are controlled using two mass flow controllers at the inlet of the column. The dehydration continued until the RH reading at the outlet of the column was less than 3% for at least 15 minutes. Following dehydration, the column was isolated by closing the inlet and outlet valves and left to cool to room temperature overnight.

In these experimental tests, the regeneration time used was twice as long as the adsorption time. The regeneration temperature is adjustable according to the hybrid used, as different hybrids would have different temperature tolerances. Similarly, the flow rate during the regeneration depends on the column size used and can be varied according to the specific needs of the user. Again, the person skilled in the art would be able to select suitable ranges and values for relevant variables.

During hydration, the stored energy was released by humidifying dry building air at room temperature to 50% or 90% RH (13 mbar or 24 mbar partial pressure of water vapour) and allowing the humid air to pass over the column, at a flow rate of 12 LPM. This allowed the water molecules in the air to be adsorbed by the adsorbent. Each hydration experiment proceeded until the humidity reading at the outlet of the column remains constant for at least 15 minutes. As the column is insulated and nearly adiabatic, this results in a temperature increase at the outlet of the column, due to the exothermic nature of adsorption. The temperature increase was monitored and recorded by a temperature sensor. The total energy released during hydration is then calculated as in equation 1, below, with the information from the column inlet and outlet temperatures, the mass flow reading from the mass flow controller, and the heat capacity of air at the given temperature and humidity level. Note that zero is the time at the start of the hydration and t is the time at the end of the experiment.

Q_{hydration}=∫₀^{t}\dot{m}ₐᵢᵣC_{p,air}(Tₒᵤₜ−Tᵢₙ)dt (1)

Based on Q_{hydration}, the energy storage density (ESD) and specific energy (SE) can be calculated. The ESD was calculated by dividing Q_{hydration} by the column volume (7.15 cm³) and the SE was calculated by dividing Q_{hydration} by the mass of the dehydrated sample. The maximum thermal power can also be calculated from these results, as the product of the maximum temperature difference between the inlet and outlet column temperatures during hydration (ΔTₘₐₓ), the specific heat capacity of air, and the mass flow rate as shown in equation 2, below.

\dot{Q}ₘₐₓ=\dot{m}ₐᵢᵣC_{p,air}ΔTₘₐₓ (2)

The absolute humidity (H) and water-vapour concentration (x_{H2O}) can be calculated according to equations 3 and 4:

$${x}_{H 2 O} = \frac{{p}_{H 2 O}^{sat} \times RH}{{P}_{tot}} \qquad ( 3 )$$

$$H = \frac{{x}_{H 2 O} \times {M}_{H 2 O}}{{x}_{H 2 O} \times {M}_{H 2 O} + ( 1 - {x}_{H 2 O} ) \times {M}_{air}} \qquad ( 4 )$$

Then, based on the difference in inlet and outlet absolute humidity over the course of the water-vapour breakthrough experiment, the water vapour uptake capacity was calculated using equation 5. Note that, at the inlet of the column, the total pressure (Pₜₒₜ) is assumed to be 101.3 kPa plus the reading on the pressure gauge by the mixing chamber (refer to FIG. 2). The pressure at the outlet of the column is assumed to be 101.3 kPa.

q=∫₀^{t}\dot{m}ₐᵢᵣ×(Hᵢₙₗₑₜ−Hₒᵤₜₗₑₜ)dt/M (b 5)

### Energy Storage Performance

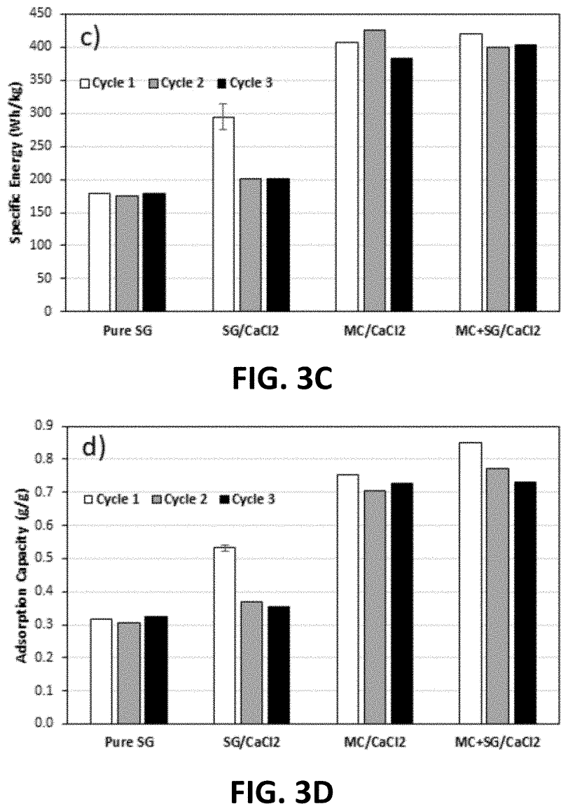

All three composite materials and pure silica gel were tested at a hydration inlet relative humidity of 50% at room temperature (≈22° C.) and a regeneration temperature of 120° C. The flow rate during both hydration and dehydration was 12 LPM. Each material underwent three consecutive dehydration and hydration cycles. Based on these experiments, the ESD, maximum thermal power, SE, and water-vapour uptake capacity were calculated for each of these three cycles. The results for all of these experiments are presented in FIGS. 3A-3D.

Pure silica gel showed low performance, apart from its relatively high maximum thermal power, but also had excellent stability. Further, its performance did not decrease during the three hydration/dehydration cycles. The SG/CaCl₂ sample had high performance on the first cycle, but much lower performance in the subsequent cycles, except for maximum thermal power. This is likely due to the salt not being properly bound to the silica gel and then detaching itself from the silica gel during hydration and leaving the column. The performance of this sample after three cycles decreases approximately to 180 kWh/m³, but is higher than that of the pure silica gel. Its performance after multiple cycles is close to that of pure silica gel, since most of the salt has likely left the matrix.

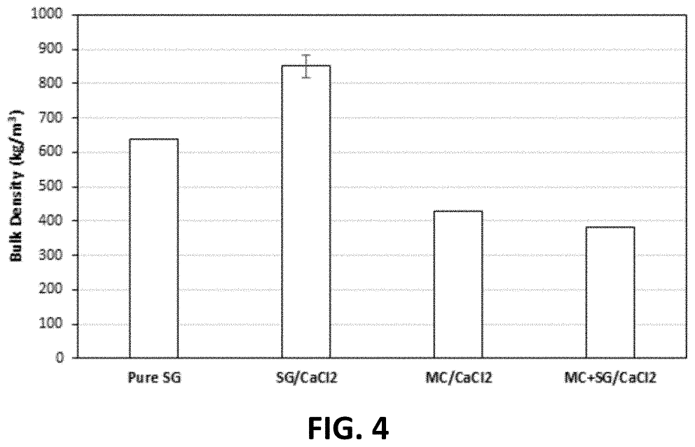

The MC/CaCl₂ and MC+SG/CaCl₂ sample also have high energy storage performance and are more stable than the SG/CaCl₂ sample. However, both of these materials show a slight decrease in performance after each cycle, implying that there may still be some instability. Additionally, the MC/CaCl₂ particles exhibited slight agglomeration after the three cycles. In FIG. 3A, it appears that, on the second and third cycles, all of the composites show similar ESD values. However, the SE of the MC/CaCl₂ and MC+SG/CaCl₂ samples are much higher. This is because the bulk density of MC/CaCl₂ and MC+SG/CaCl₂ was much lower than that of the SG/CaCl₂ sample and pure silica gel, as can be seen in FIG. 4.

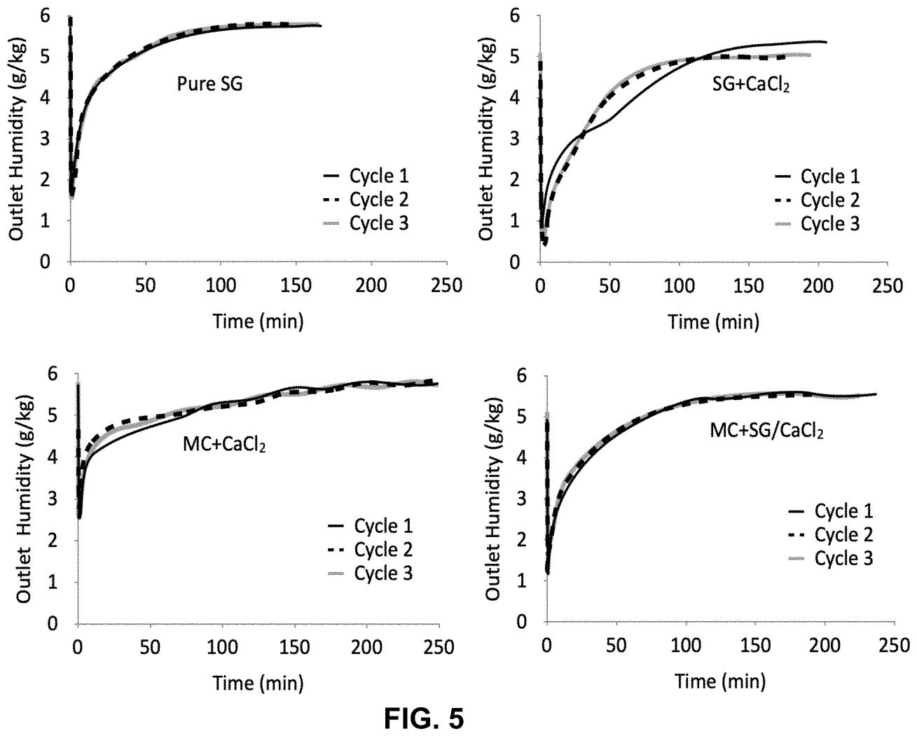

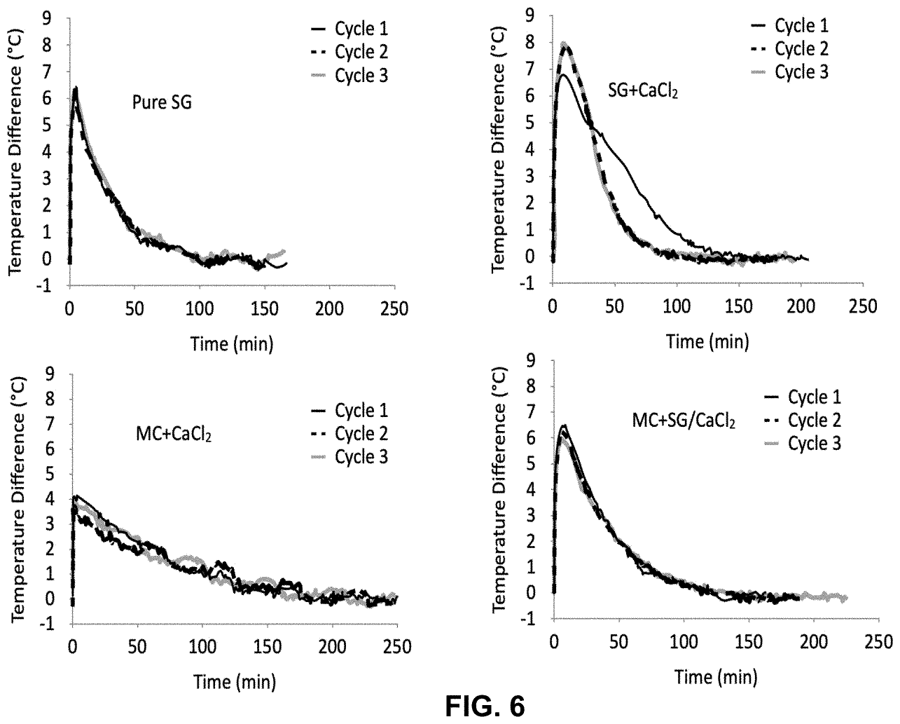

The temperature and concentration breakthrough curves for four materials (i.e., pure SG and the three CaCl₂-based composites) were plotted for three cycles (see FIGS. 5 and 6). Note that not all of the trials exhibited the same outlet humidity at the end of the hydration. This is because the pressure drop was not the same for all samples and therefore the inlet total pressure was different for each sample. This resulted in variance in the inlet humidity, as per equations 3 and 4 above.

Referring to FIG. 5, it is seen that the pure silica gel breakthrough curves are nearly superimposed for cycles 1 to 3. It is also apparent that the SG/CaCl₂ exhibits a significant change after the first cycle, which completely changes the shape of the breakthrough curve. The MC/CaCl₂ sample showed a more gradual and sluggish breakthrough behavior. This sample also shows higher variations in humidity readings compared to the other samples, since it was more sensitive to the atmospheric temperature. (As MC/CaCl₂ is known to swell slightly, its column was packed very loosely, meaning that there was less solid material to act as a heat sink. As a result, this sample was more directly affected by the ambient temperature, which oscillated due to the temperature control system in the laboratory. This is further supported by the temperature oscillations seen in FIG. 6 for MC/CaCl₂.) The MC+SG/CaCl₂ breakthrough curve was similar to that of pure silica gel but with a slightly lesser slope. There is also a slight but discernable increase in the rate of change of the outlet humidity for this sample as the number of cycles increases. This is likely related to the water-vapour uptake capacity slightly decreasing after multiple cycles (referring back to FIG. 3D).

Referring now to FIG. 6, the pure silica gel temperature breakthrough curve shows a sudden and sharp increase at the beginning of the experiment, followed by a very long tail. All three cycles exhibit similar behavior. For the first cycle for the SG/CaCl₂ sample, a large initial temperature lift is observed, then the temperature difference decreases almost linearly and finally tails off. However, in the subsequent two cycles, the maximum temperature lift is higher, but the tailing is more rapid. This ultimately reduces the area under the curve and therefore the ESD (referring back to FIG. 3A). However, the second and third cycles for SG/CaCl₂ are almost coincident, further suggesting there is a significant change in the material properties after the first cycle but very little change after the second.

The MC/CaCl₂ breakthrough shown in FIG. 6 again experiences oscillations due to changes in ambient temperature (again, likely due to the loose packing). However, the MC+SG/CaCl₂ sample generally shows an initial peak in temperature difference then a long tail, similar to pure silica gel but with a lower maximum temperature difference and a broader tailing. As the cycle number increases, the maximum temperature lift decreases and the overall area under the curve decreases, implying that the ESD, SE, and maximum thermal power decrease slightly after each cycle, as is shown in FIG. 3C.

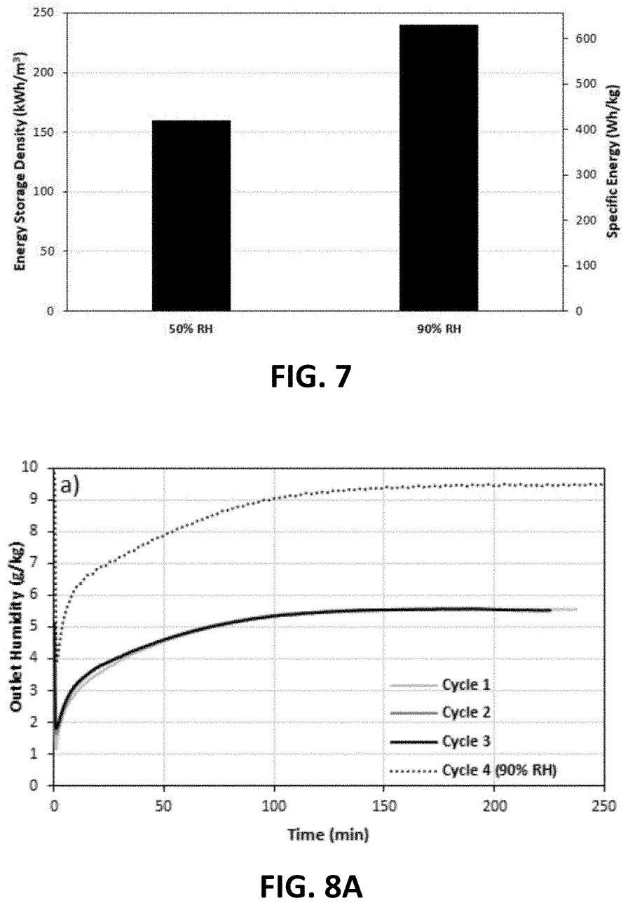

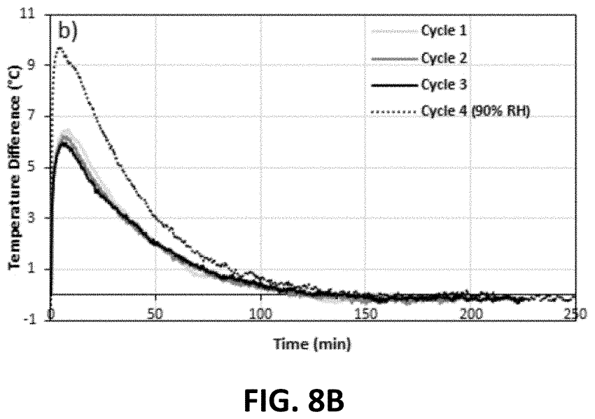

The MC+SG/CaCl₂ sample exhibited the best energy storage performance and stability out of the tested materials. Further, unlike MC/CaCl₂, the MC+SG/CaCl₂ sample did not exhibit practical issues such as swelling or agglomeration. As such, a fourth dehydration at 120° C. and fourth hydration at an inlet humidity of 90% RH was performed. The energy storage performance and breakthrough curves under these conditions are given in FIG. 7 and FIGS. 8A and 8B, respectively.

As is seen, the ESD and SE of the MC+SG/CaCl₂ increased by 50% when the inlet

RH was increased from 50% to 90%. Additionally, the concentration and temperature breakthrough behaviours were significantly affected. The slope of the concentration breakthrough curve at the start of the experiment was much larger when the inlet RH is 90% and the maximum temperature difference is about 4° C. higher than the three cycles at an inlet RH of 50%.

### Method Flowchart

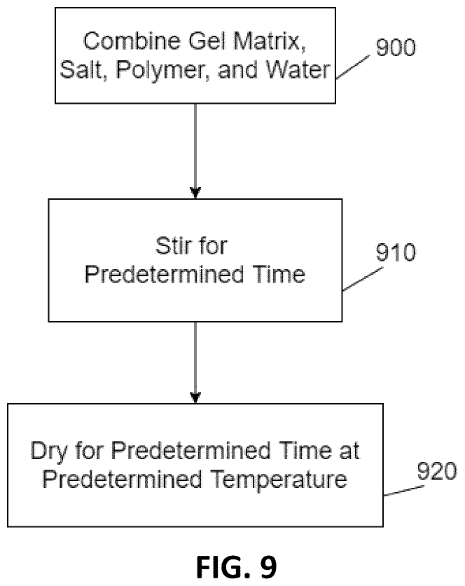

Referring now to FIG. 9, a flowchart detailing a method according to one aspect of the invention is shown. At step 900, a salt (i.e., a salt hydrate or salt hydrate composite) is combined with a matrix, a polymer (i.e., methyl cellulose), and a mixing agent such as water. As described above, the combination may be performed in steps, wherein some components are separately combined before others are added. Alternatively, all components may be combined at one time. As well, other components, such as (without limitation) purifying agents, such as methanol, can also be combined with the mixture.

At step 910, the mixture is stirred for a predetermined time, to allow the impregnation and encapsulation processes to occur. At step 920, the stirred mixture is dried at a predetermined temperature for a predetermined time.

Encapsulation of composite is an emerging technology to stabilize the energy storage density for multiple cycles and solve the deliquescence issues. The stabilization of the composite of silica gel and calcium chloride has been shown. The composite has shown exceptional performance. Accordingly, the flax shives/CaCl₂ composite h as been tried and this has shown less stability. To make it stable, this has been encapsulated with methylcellulose. The encapsulated composite has an energy storage density of 350 kWh/m3 at 50% RH at the inlet after regeneration at 120° C. The composite is quite stable for three cycles. This energy storage density is much higher than the energy storage densities reported in the literature for this type of thermal energy storage using moisture adsorption from air.

As noted above, for a better understanding of the present invention, the following references may be consulted. Each of these references is hereby incorporated by reference in its entirety:
[1] D. Lefebvre and F. H. Tezel, “A review of energy storage technologies with a focus on adsorption thermal energy storage processes for heating applications,” Renew. Sustain. Energy Rev., vol. 67, pp. 116-125, 2017;
[2] P. A. J. Donkers, L. C. Sügütoglu, H. P. Huinink, H. R. Fischer, and 0. C. G. Adan, “A review of salt hydrates for seasonal heat storage in domestic applications,” Appl. Energy, vol. 199, pp. 45-68, 2017;
[3] L. Scapino, H. A. Zondag, J. Van Bael, J. Diriken, and C. C. M. Rindt, “Sorption heat storage for long-term low-temperature applications: A review on the advancements at material and prototype scale,” Appl. Energy, vol. 190, pp. 920-948, 2017;
[4] D. Zhu, H. Wu, and S. Wang, “Experimental study on composite silica gel supported CaCl2 sorbent for low grade heat storage,” Int. J. Therm. Sci., vol. 45, no. 8, pp. 804-813,2006;
[5] L. G. Gordeeva, J. Mrowiec-Bialon, A. B. Jarzebski, A. I. Lachowski, J. J. Malinowski, and Y. I. Aristov, “Selective water sorbents for multiple applications, 8. Sorption properties of CaCl2-SiO2 SOL-gel composites,” React. Kinet. Catal. Lett., vol. 66, no. 1, pp. 113-120, 1999;
[6] A. Jabbari-Hichri, S. Bennici, and A. Auroux, “Enhancing the heat storage density of silica—alumina by addition of hygroscopic salts (CaCl2, Ba(OH)2, and LiNO3),” Sol. Energy Mater. Sol. Cells, vol. 140, pp. 351-360, 2015;
[7] M. Tokarev, L. Gordeeva, V. Romannikov, and I. Glaznev, “New composite sorbent CaCl2 in mesopores for sorption cooling/heating,” vol. 41, pp. 470-474, 2002;
[8] J. G. Ji, R. Z. Wang, and L. X. Li, “New composite adsorbent for solar-driven fresh water production from the atmosphere,” Desalination, vol. 212, no. 1-3, pp. 176-182, 2007;
[9] E. Courbon, P. D′Ans, A. Permyakova, O. Skrylnyk, N. Steunou, M. Degrez, M. Frère, “Further improvement of the synthesis of silica gel and CaCl2 composites: Enhancement of energy storage density and stability over cycles for solar heat storage coupled with space heating applications,” Sol. Energy, vol. 157, no. September, pp. 532-541,2017.
[10] Y. Hua, A. Godin, and F. H. Tezel, “Water Vapor Adsorption In Silica Gel For Thermal Energy Storage Application,” Adv. Mater. Lett., vol. 10, no. 2, pp. 124-127, 2019;
[11] M. Gaeini, A. L. Rouws, J. W. O. Salari, H. A. Zondag, and C. C. M. Rindt, “Characterization of microencapsulated and impregnated porous host materials based on calcium chloride for thermochemical energy storage,” Appl. Energy, vol. 212, no. May 2017, pp. 1165-1177, 2018;
[12] A. Shkatulov, R. Joosten, H. Fischer, and H. Huinink, “Core-Shell Encapsulation of Salt Hydrates into Mesoporous Silica Shells for Thermochemical Energy Storage,” ACS Appl. Energy Mater., vol. 3, no. 7, pp. 6860-6869, 2020;
[13] R. Cuypers A. J. de. Jong, J. Eversdijk, J. C. van't. Spijker, H. P. Oversloot, B. L. J. Ingenhut, R. K. H, Cremers, and N. E. Papen-Botterhuis, “Microencapsulation of Salts for Enhanced Thermochemical Storage Materials.,” in 40th Annual Meeting and Exposition of the Controlled Release Society, 2013, pp. 1-2;
[14] Y. N. Zhang, R. Z. Wang, and T. X. Li, “Experimental investigation on an open sorption thermal storage system for space heating,” Energy, vol. 141, pp. 2421-2433, 2017;
[15] I. Glaznev, I. Ponomarenko, S. Kirik, and Y. Aristov, “Composites CaCl2/SBA-15 for adsorptive transformation of low temperature heat : Pore size effect,” Int. J. Refrig., vol. 34, no. 5, pp. 1244-1250, 2011;
[16] A. ParmyakovaS. Wang, E. Courbon, F. Nouar, N. Heymans, P. D′Ans, N. Barrier, P. Billemont, G. D. Weireld, N. Steunou, M. Frère and C. Serre,“Design of salt-metal organic framework composites for seasonal heat storage applications,” J. .Mater. Chem. A, vol. 5, pp. 12889-12898, 2017;
[17] A. Jabbari-Hichri, S. Bennici, and A. Auroux, “CaCl2 -containing composites as thermochemical heat storage materials,” Sol. Energy Mater. Sol. Cells, vol. 172, no. July, pp. 177-185, 2017;
[18] Y. I. Aristov, G. Di Marco, M. Tokarev, and V. Parmon, “Selective water sorbents for multiple applications, 3. CaCl2 solution confined in micro- and mesoporous silica gels: Pore size effect on the ‘solidification-melting’ diagram,” React. Kinet. Catal. Lett., vol. 61, no. 1, pp. 147-154, 1997; and
[19] R. Sutton, E. Jewell, J. Searle, and J. Elvins, “Discharge performance of blended salt in matrix materials for low enthalpy thermochemical storage,” Appl. Therm. Eng., vol. 145, no. September, pp. 483-493, 2018

A person understanding this invention may now conceive of alternative structures and embodiments or variations of the above all of which are intended to fall within the scope of the invention as defined in the claims that follow.

We claim:

1. A composite material for thermochemical energy storage (TCES), said material comprising:
at least one of a salt hydrate and a salt hydrate composite;
a matrix; and
a polymer,
wherein said at least one of said salt hydrate and said salt hydrate composite is impregnated into said matrix to thereby produce an impregnated matrix, and wherein said impregnated matrix is encapsulated by said polymer.

2. The material according to claim 1, wherein said matrix is a gel matrix.

3. The material according to claim 1, wherein said at least one of said salt hydrate and said salt hydrate composite is calcium chloride (CaCl₂).

4. The material according to claim 1, wherein said at least one of said salt hydrate and said salt hydrate composite is a calcium chloride-based composite.

5. The material according to claim 1, wherein said matrix is silica gel.

6. The material according to claim 1, wherein said polymer is at least one of methylcellulose (MC) and ethyl cellulose.

7. The material according to claim 1, wherein impregnation of said matrix with said at least one of said salt hydrate and said salt hydrate composite and encapsulation of said impregnated matrix are performed simultaneously.

8. The material according to claim 1, said material further comprising ethanol.

9. A method of producing a composite material for thermochemical energy storage (TCES), said method comprising:
combining a matrix, a polymer, deionized water, and at least one of a salt hydrate and a salt hydrate composite to form a mixture;
stirring said mixture, such that said at least one of said salt hydrate and said salt hydrate composite is impregnated into said matrix to thereby produce an impregnated matrix, and said impregnated matrix is encapsulated by said polymer; and
drying said mixture to thereby produce said composite material.

10. The method according to claim 9, wherein said matrix is a gel matrix.

11. The method according to claim 9, wherein said at least one of said salt hydrate and said salt hydrate composite is calcium chloride (CaCl₂).

12. The method according to claim 9, wherein said at least one of said salt hydrate and said salt hydrate composite is a calcium chloride-based composite.

13. The method according to claim 9, wherein said matrix is silica gel.

14. The method according to claim 9, wherein said polymer is at least one of methylcellulose (MC) and ethyl cellulose.

15. The method according to claim 9, wherein ethanol is also combined in said mixture.

16. A composite material for thermochemical energy storage (TCES), said material comprising:
a hygroscopic salt; and
a polymer, wherein said polymer encapsulates said hygroscopic salt and wherein said polymer is methylcellulose.
